(19) United States
(12) Patent Application Publication
(10) Pub. No.: US 2016/0035478 A1
(43) Pub. Date: Feb. 4, 2016

(54) MAGNETIC DEVICE

(71) Applicant: OMRON AUTOMOTIVE ELECTRONICS CO., LTD., Aichi (JP)

(72) Inventors: Shusuke Furui, Aichi (JP); Toshiyuki Takeuchi, Nagano (JP); Takashi Yamaguchi, Aichi (JP)

(73) Assignee: OMRON AUTOMOTIVE ELECTRONICS CO., LTD., Aichi (JP)

(21) Appl. No.: 14/777,349

(22) PCT Filed: Mar. 10, 2014
(86) PCT No.: PCT/JP2014/001324

§ 371 Date: Sep. 15, 2015

(30) Foreign Application Priority Data
Mar. 15, 2013 (JP) 2013-052698

(51) Int. Cl. H01F 27/28; H01F 27/29

(52) U.S. Cl. CPC H01F 27/2804; H01F 27/29; H01F 2027/2809

(57) ABSTRACT

Coil patterns are provided in layers of a board to be wound in a same direction. The coil pattern is wound outwardly in a last layer on a rear-most side and in each even-numbered layer. The coil pattern is wound inwardly in each odd-numbered layer other than the last layer. An inner end portion of the coil pattern in each odd-numbered layer is connected to an inner end portion of the coil pattern in an adjacent back-side layer. An outer end portion of the coil pattern in each even-numbered layer, and an outer end portion of the coil pattern in an adjacent back side layer or an inner end portion of the coil pattern in the last layer are connected by the individual inter-layer connection portion. Outer end portions of the coil patterns in a first-numbered layer and the last layer are connected to respective terminal portions.

### TECHNICAL FIELD

The present invention relates to a magnetic device such as a choke coil and a transformer, which includes a core formed of a magnetic substance and a board having a formed coil pattern.

### BACKGROUND ART

For example, there is a switching power supply apparatus such as a DC-DC converter, which performs switching so as to convert a DC high voltage DC into an AC voltage, and then converts the AC voltage into a DC low voltage. A magnetic device such as a choke coil and a transformer is used in the switching power supply apparatus.

Patent Document 1 and Patent Document 2 disclose a magnetic device in which a coil pattern formed in a board constitutes a winding wire of a coil. In this magnetic device, an opening portion for inserting a convex portion of a core is provided in the board. Coil patterns are provided in layers of the board so as to be wound around the opening portion. The coil patterns in the layers different from each other are connected to each other by an inter-layer connection portion such as a through hole. Power is input to and output from the coil patterns through a pair of terminal portions of a pin, a through hole, and the like.

In Patent Document 1, the coil patterns are provided in each of layers of an even number of the board so as to have N (integer of one or more)+1 turns and the width of a wire-wound portion on the innermost side is half of the width of other wire-wound portions. Wire-wound portions on the innermost side in two adjacent layers are connected to each other in parallel by using a through hole, and thus the total number of winding of the coil pattern is 2N+1 turns. In Patent Document 2, the coil patterns are provided in each of layers of an even number of the board so as to have 0.5 to 2 turns.

### PRIOR ART DOCUMENT(S)

### Patent Document(s)

Patent Document 1: JP-A-2002-280230

Patent Document 2: JP-A-H08-69935

### SUMMARY OF THE INVENTION

### Problem to be Solved by the Invention

If a coil pattern is wound a plurality of times in layers of the board or the number of layers in the board, in which the coil pattern is provided, increases, the total number of winding becomes greater and thus it is possible to achieve predetermined performance of a coil. However, wiring such as routing and connection of the coil pattern becomes difficult or the size of the coil pattern becomes greater in a plate face direction or a thickness direction of the board.

An object of the present invention is to provide a magnetic device which can have many numbers of winding of a coil pattern with the small numbers of layers, and can easily perform wiring of the coil pattern.

### Means for Solving the Invention

According to the present invention, there is provided a magnetic device which includes a core and a board having an opening portion for inserting the core. Coil patterns are provided in a plurality of layers of the board so as to be wound around the opening portion. The coil patterns in the layers different from each other are connected to each other by inter-layer connection portions. Power is input to and output from the coil patterns through a pair of terminal portions. The coil patterns are provided in respective layers of an odd number of three or more of the board, so as to be wound a plurality of times in a same direction. The coil pattern is wound outwardly in a last layer on a rear-most surface side of the board among the layers. The coil pattern is wound inwardly in each of other odd-numbered layers from a front surface side of the board other than the last layer. The coil pattern is wound outwardly in each of even-numbered layers. An inner end portion of the coil pattern in each of the odd-numbered layers and an inner end portion of the coil pattern in each of the even-numbered layers which is adjacent to the corresponding odd-numbered layer on a back surface side of the board are connected to each other by an individual inter-layer connection portion. An outer end portion of the coil pattern in each of the even-numbered layers, and an outer end portion of the coil pattern in each of the odd-numbered layers adjacent to the corresponding odd-numbered layer on the back surface side of the board or an inner end portion of the coil pattern in the last layer are connected to each other by the individual inter-layer connection portion. An outer end portion of the coil pattern in a first-numbered layer from the front surface side of the board is connected to one of the pair of terminal portions. An outer end portion of the coil pattern in the last layer is connected to the other of the pair of terminal portions.

Thus, since the coil patterns are wound a plurality of times in each of three odd-numbered layers or more of the board, the number of winding of the coil pattern as the entirety is twice or more the number of the layers of an odd number, and thus it is possible to cause the number of winding of the coil pattern to become greater with the small numbers of the layers. The coil patterns are routed spirally in the layers by performing inward winding or outward winding. The coil patterns in adjacent layers are connected to each other at the inner end portion or the outer end portion by the inter-layer connection portion provided in the board. For this reason, for example, connection of the terminal portion and the coil patterns by out-of-board wiring using a separate lead wire and the like is not required, and it is possible to easily perform wiring of the coil pattern. It is possible to reduce the size of the board in a plate face direction by disposing the coil pattern and the inter-layer connection portion so as to approach the vicinity of the opening portion of the board.

According to the present invention, in the magnetic device, the board may be formed of a three-layer board. The coil pattern may be wound inwardly in a first layer on the front-most surface side of the board. The coil pattern may be wound outwardly in a second layer from the front surface side of the board. The coil pattern may be wound outwardly in a third layer on a rear-most surface side of the board. The inter-layer connection portion may be formed of a first inter-layer connection portion and a second inter-layer connection portion. The first inter-layer connection portion may connect an inner end portion of the coil pattern in the first layer and an inner end portion of the coil pattern in the second layer. The second inter-layer connection portion may connect an outer end portion of the coil pattern in the second layer and an inner end portion of the coil pattern in the third layer. An outer end portion of the coil pattern in the first layer may be connected to the one of the pair of terminal portions. An outer end portion of the coil pattern in the third layer is connected to the other of the pair of terminal portions.

According to the present invention, in the magnetic device, the first inter-layer connection portion and the second inter-layer connection portion may pass through each of the layers of the board.

According to the present invention, in the magnetic device, the coil patterns may be provided in each of layers of an odd number of five or more of the board, and each of the inter-layer connection portions may be formed of a via which does not pass through the board.

According to the present invention, in the magnetic device, the pair of terminal portions may be provided on an outside of an outer circumference of the coil pattern.

### Advantage of the Invention

According to the present invention, a magnetic device which can have many numbers of winding of a coil pattern with the small numbers of layers, and can easily perform wiring of the coil pattern can be provided.

### BRIEF DESCRIPTION OF THE DRAWINGS

FIG. 1 is a configuration diagram of a switching power supply apparatus.

FIG. 2 is an exploded perspective view of a magnetic device according to embodiments of the present invention.

FIGS. 3(a) to 3(c) are plan views of layers of a board of a magnetic device according to a first embodiment.

FIG. 4 is a Y-Y cross-sectional view in FIGS. 3(a) to 3(c).

FIG. 5 is a V-V cross-sectional view in FIGS. 3(a) to 3(c).

FIGS. 6(a) to 6(e) are plan view of main portions of each layer of a board in a magnetic device according to a second embodiment.

FIG. 7 is a V′-V′ cross-sectional view in FIGS. 6(a) to 6(e).

### MODE FOR CARRYING OUT THE INVENTION

Hereinafter, embodiments according to the present invention will be described with reference to the drawings. In each of the drawings, the same parts or the corresponding parts are denoted by the same reference signs.

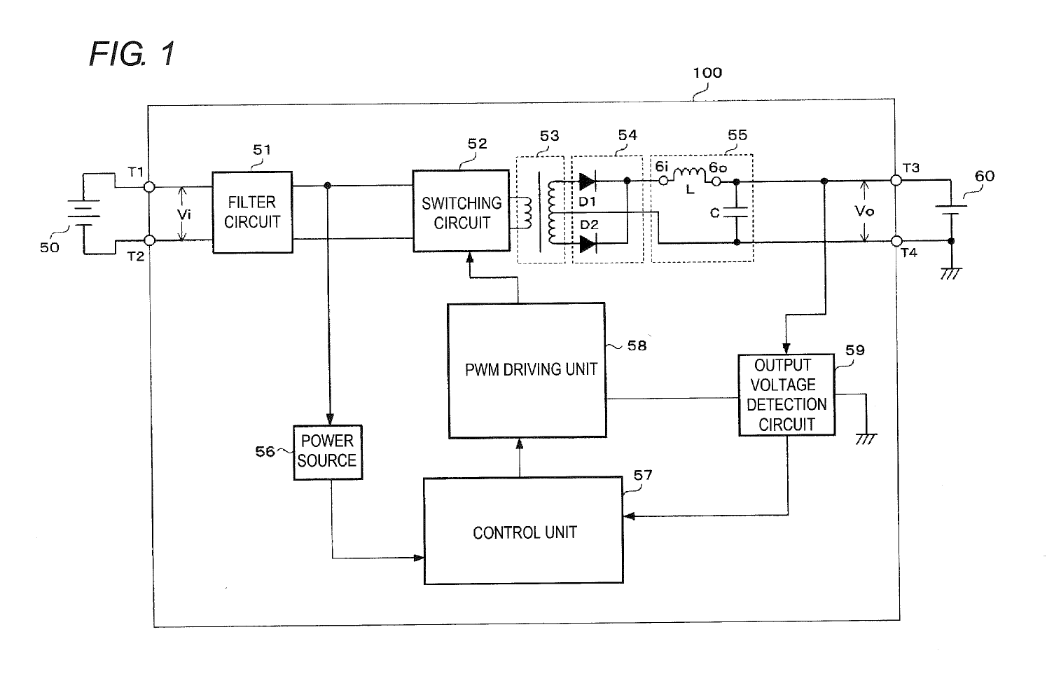

FIG. 1 is a configuration diagram of a switching power supply apparatus 100. The switching power supply apparatus 100 is a DC-DC converter for an electric vehicle (or hybrid car). The switching power supply apparatus 100 performs switching so as to convert a DC high voltage into an AC voltage, and then converts the AC voltage into a DC low voltage. Details thereof will be described below.

A high voltage battery 50 is connected to input terminals T1 and T2 of the switching power supply apparatus 100. A voltage of the high voltage battery 50 is, for example, in a range of DC 220 V to DC 400 V. A noise is removed from a DC voltage Vi of the high voltage battery 50 input to the input terminals T1 and T2 by a filter circuit 51, and then a result of removal is applied to a switching circuit 52.

The switching circuit 52 is formed of a well-known circuit having, for example, a field effect transistor (FET). In the switching circuit 52, the FET is caused to turn ON and OFF based on a pulse width modulation (PWM) signal from a PWM driving unit 58 and a switching operation is performed on the DC voltage. Thus, the DC voltage is converted into a high-frequency pulse voltage.

The converted pulse voltage is applied to a rectifier circuit 54 through a transformer 53. The rectifier circuit 54 rectifies the pulse voltage by using a pair of diodes D1 and D2. A voltage rectified by the rectifier circuit 54 is input to a smoothing circuit 55. The smoothing circuit 55 smooths the rectified voltage by a filter action which is performed by a choke coil L and a capacitor C. The smoothed voltage is output to output terminals T3 and T4 as a low DC voltage. A low voltage battery 60 connected to the output terminals T3 and T4 is charged so as to be, for example, DC 12 V by using this DC voltage. A DC voltage of the low voltage battery 60 is supplied to various types of vehicle-mounted electric components (not illustrated).

An output voltage Vo of the smoothing circuit 55 is detected by an output voltage detection circuit 59 and then is output to the PWM driving unit 58. The PWM driving unit 58 calculates a duty ratio of a PWM signal based on the output voltage Vo, and generates the PWM signal in accordance with the duty ratio. The PWM driving unit 58 outputs the generated PWM signal to a gate of the FET in the switching circuit 52. Thus, feedback control for holding the output voltage to be constant is performed.

A control unit 57 controls an operation of the PWM driving unit 58. A power source 56 is connected to an output side of the filter circuit 51. The power source 56 steps down a voltage of the high voltage battery 50 and supplies a power source voltage (for example, DC 12 V) to the control unit 57.

In the switching power supply apparatus 100, magnetic devices 1 and 1′ which will be described later are used as the choke coil L in the smoothing circuit 55. A high current of, for example, DC 150 A flows in the choke coil L. A pair of terminals 6i and 6o for inputting and outputting power are provided at both ends of the choke coil L.

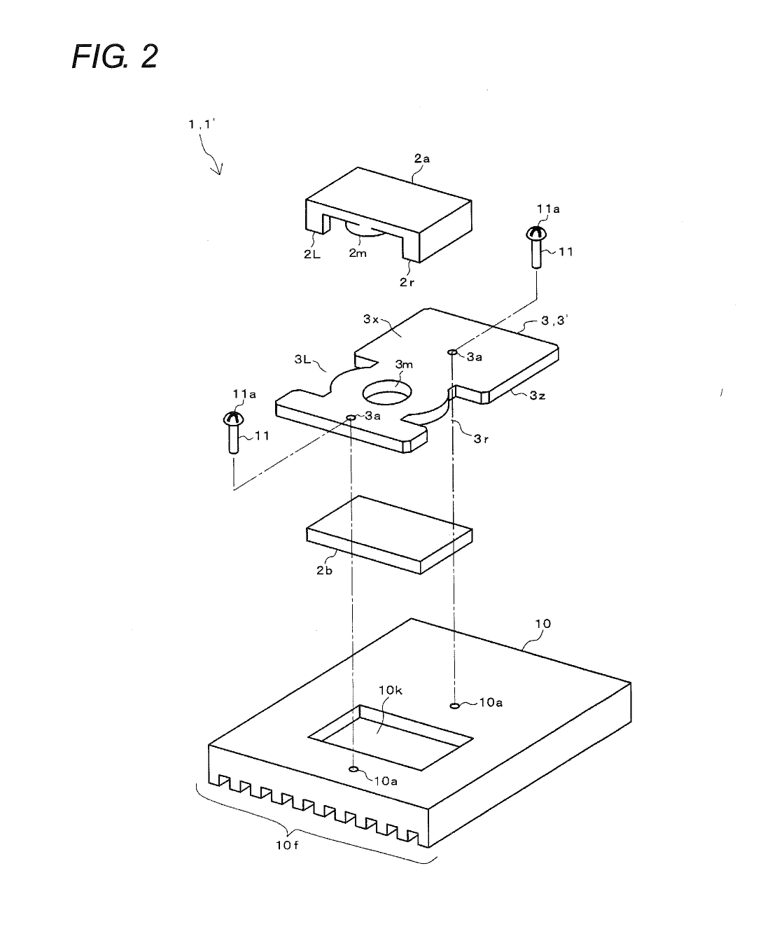

Next, a structure of the magnetic device 1 according to a first embodiment will be described with reference to FIGS. 2 to 5.

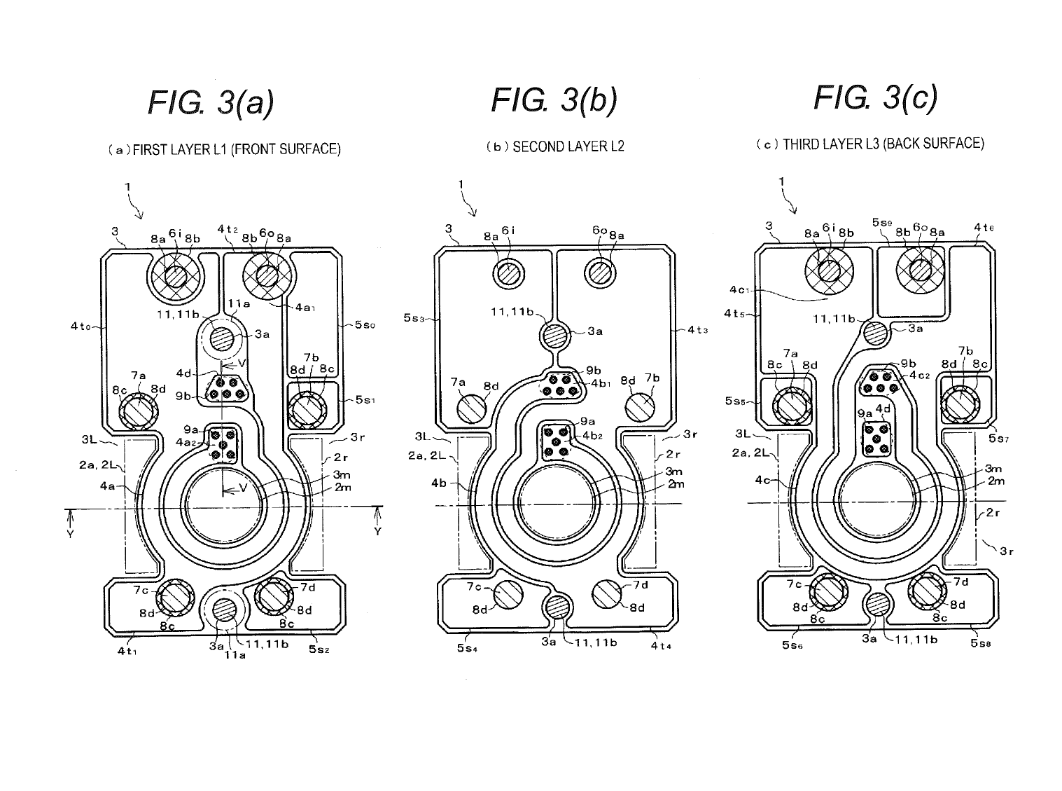

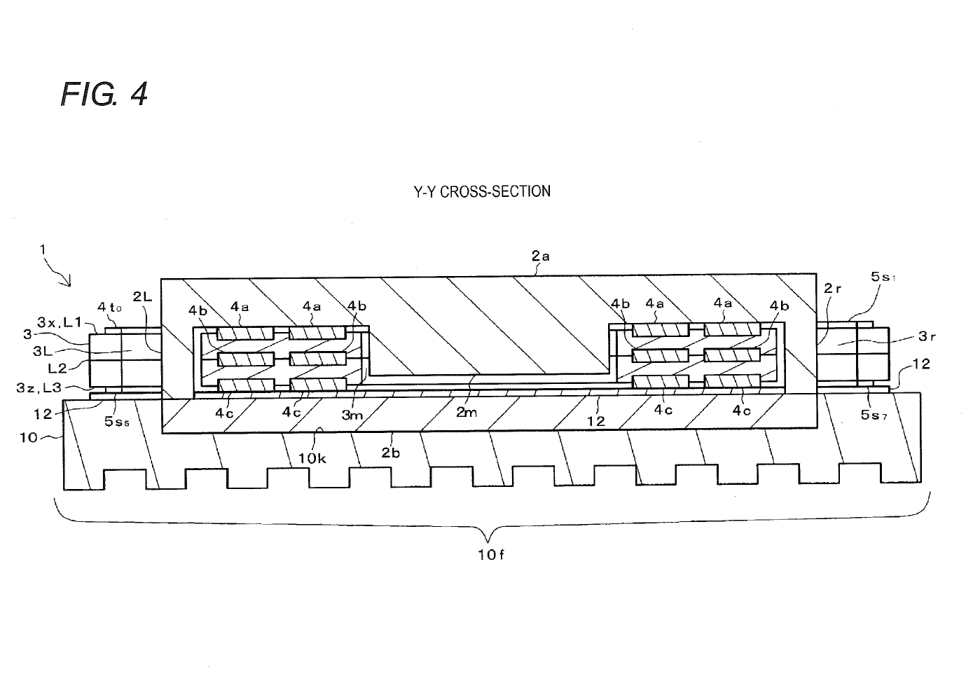

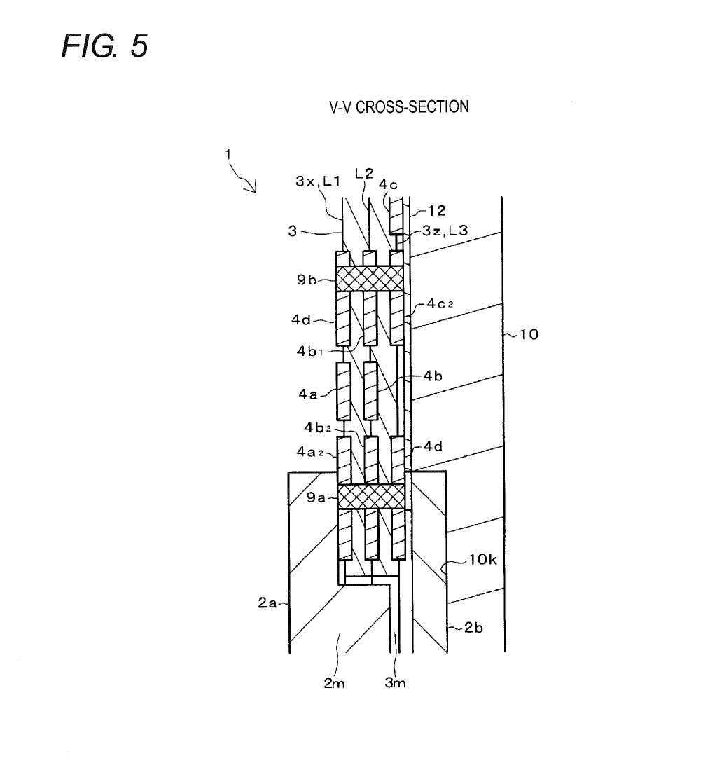

FIG. 2 is an exploded perspective view of the magnetic device 1 (also similar in the magnetic device 1′ which will be described later). FIGS. 3(a) to 3(c) are plan views of layers in the board 3 of the magnetic device 1. FIGS. 4 and 5 are cross-sectional views of the magnetic device 1; FIG. 4 illustrates a Y-Y cross-section in FIGS. 3(a) to 3(c), and FIG. 5 illustrates a V-V cross-section in FIGS. 3(a) to 3(c).

As illustrated in FIG. 2, cores 2a and 2b are configured by a pair of two, that is, an upper core 2a and a lower core 2b. The upper core 2a has an E-shape and the lower core 2b has an I-shape. The cores 2a and 2b are formed of a magnetic substance such as ferrite or an amorphous metal.

The upper core 2a has three convex portions 2m, 2L, and 2r so as to protrude downwardly. The convex portions 2m, 2L, and 2r are arranged in a row as illustrated in FIG. 3. As illustrated in FIG. 2, a protrusion amount of the right and left convex portions 2L and 2r is more than a protrusion amount of the center convex portion 2m.

As illustrated in FIG. 4, lower ends of the right and left convex portions 2L and 2r of the upper core 2a adhere to an upper surface of the lower core 2b and thus the cores 2a and 2b are combined. Since DC superimposition characteristics are strengthened in this state, a gap of a predetermined size is provided between the convex portion 2m of the upper core 2a and the upper surface of the lower core 2b. Thus, even when a high current flows in the magnetic device 1 (choke coil L), it is possible to realize a predetermined inductance. The cores 2a and 2b are fixed to each other by fixation means (not illustrated) such as a screw and metal fittings.

The lower core 2b is fit into a concave portion 10k (FIG. 2) provided on an upside of a heat sink 10. A fin 10f is provided on a downside of the heat sink 10.

The board 3 is configured from a thick copper foil board obtained by forming a pattern on each layer of a thin plate-like base with a thick copper foil (conductor). The thin plate-like base is formed of an insulating substance. In this embodiment, other electronic components or other circuits are not provided on the board 3. However, when the magnetic device 1 is practically used in the switching power supply apparatus 100 in FIG. 1, other electronic components or other circuits are provided on the same board, in addition to the magnetic device 1 and the switching power supply apparatus 100 (also similar in the magnetic device 1′ which will be described later).

A first layer L1 as illustrated in FIG. 3(a) is provided on a front surface 3x (upper surface in FIGS. 2 and 4) of the board 3. A third layer L3 as illustrated in FIG. 3(c) is provided on a back surface 3z (lower surface in FIGS. 2 and 4) of the board 3. As illustrated in FIGS. 4 and 5, a second layer L2 as illustrated in FIG. 3(b) is provided between the first layer L1 and the third layer L3.

That is, the board 3 has three (odd number) layers L1, L2, and L3 of the two outer layers L1 and L3, and the one inner layer L2. The first layer L1 is a first (odd-numbered) layer from the front surface 3x side of the board 3. The second layer L2 is a second (even-numbered) layer from the front surface 3x side of the board 3. The third layer L3 is the last layer on the rear-most surface 3z side.

An opening portion 3m formed of a circular through hole having a large diameter, and notches 3L and 3r are provided in the board 3. As illustrated in FIGS. 2 to 4, the center convex portion 2m of the core 2a is inserted into the opening portion 3m. The right and left convex portions 2L and 2r of the core 2a are inserted into the right and left notches 3L and 3r.

Two circular through holes 3a having a small diameter are provided in the board 3. As illustrated in FIG. 2, screws 11 are respectively inserted into the through holes 3a. The back surface 3z of the board 3 faces the upper surface (surface opposite to the fin 10f) of the heat sink 10. The screw 11 is caused to pass through the through hole 3a from the front surface 3x side of the board 3 and is screwed into the screw hole 10a of the heat sink 10. Thus, as illustrated in FIGS. 4 and 5, the heat sink 10 is fixed to the back surface 3z side of the board 3 in a proximity state. A head portion 11a having a diameter larger than that of a shaft portion 11b of the screw 11 is disposed on the front surface 3x side of the board 3 (see FIG. 3(a)).

An insulating sheet 12 having a heat transfer property is interposed between the board 3 and the heat sink 10. Since the insulating sheet 12 has flexibility, the insulating sheet 12 adheres to the board 3 or the heat sink 10 without a gap.

As illustrated in FIGS. 3(a) to 3(c), conductors such as through holes 8a, 8d, 9a, and 9b, pads 8b and 8c, terminals 6i and 6o, patterns 4a to 4d, 4t₀ to 4t₆, and 5s₀ to 5s₉, and pins 7a to 7d are provided in the board 3. The through holes 8a, 8d, 9a, and 9b, the terminals 6i and 6o, and the pins 7a to 7d are provided so as to pass through the board 3.

The terminal 6i is buried in one of a pair of through holes 8a, and the terminal 6o is buried in another of the pair of through holes 8a. The pair of terminals 6i and 6o are formed of copper pins. Pads 8b of the through holes 8a are provided around the terminals 6i and 6o in the first layer L1 and the third layer L3. The pads 8b are formed of copper foils. Copper plating is performed on front surfaces of the terminals 6i and 6o or the pads 8b. The terminals 6i and 6o are an example of a “terminal portion” according to the present invention.

Heat-dissipation pins 7a to 7d are respectively buried into a plurality of through holes 8d having a large diameter. The heat-dissipation pins 7a to 7d are formed of copper pins. Pads 8c formed of copper foils are provided around the heat-dissipation pins 7a to 7f in the first layer L1 and the third layer L3. Copper plating is performed on front surfaces of the heat-dissipation pins 7a to 7d or the pads 8c.

Coil patterns 4a to 4c and heat-dissipation patterns 4t₀ to 4t₆ and 5s₀ to 5s₉ are provided in layers L1 to L3 of the board 3. Each of the patterns 4a to 4d, 4t₀ to 4t₆, and 5s₀ to 5s₉ are formed of copper foils. Insulating processing is performed on front surfaces of the patterns 4a, 4t₀ to 4t₂, and 5s₀ to 5s₂ in the first layer L1.

The coil patterns 4a to 4c are formed so as to have a band shape of being parallel with a plate face direction of the board 3. The width, the thickness, or the cross-sectional area of the coil patterns 4a to 4c is set to achieve predetermined performance of a coil and to suppress heat quantities in the coil patterns 4a to 4c up to a certain extent and enable heat dissipation from the front surfaces of the coil patterns 4a to 4c even when a predetermined high current (for example, DC 150 A) flows.

As illustrated in FIGS. 3(a) to 3(c), the coil patterns 4a to 4c are wound a plurality of times around the opening portion 3m into which the center convex portion 2m of the core 2a is inserted in each of the layers L1 to L3, in the same direction. The pair of terminals 6i and 6o for inputting and outputting power to and from the coil patterns 4a to 4c is provided on the outside of an outer circumference of the coil patterns 4a to 4c.

As illustrated in FIG. 3(a), an outer end portion 4a₂ of the coil pattern 4a is connected to the terminal 6o through the pad 8b and the through hole 8a in the first layer L1. The coil pattern 4a is wound inwardly twice clockwise around the opening portion 3m from the outer end portion 4a₁ (inward winding). As illustrated in FIG. 5, an inner end portion 4a₂ of the coil pattern 4a is connected to an inner end portion 4b₂ of the coil pattern 4b in the second layer L2 adjacent to the first layer L1 on the back surface 3z side of the board 3 by using a through hole 9a.

As illustrated in FIG. 3(b), the coil pattern 4b in the second layer L2 is wound outwardly twice clockwise around the opening portion 3m from the inner end portion 4b₂ (outward winding). As illustrated in FIG. 5, an outer end portion 4b₁ of the coil pattern 4b is connected to an inner end portion 4c₂ of the coil pattern 4c in the third layer L3 adjacent to the second layer L2 on the back surface 3z side of the board 3 by using a through hole 9b.

That is, the coil patterns in two layers which are different from each other and are adjacent to each other are connected to each other by using separate through holes 9a and 9b. As illustrated in FIG. 3, a plurality of through holes having a small diameter is provided as each of the through holes 9a and 9b, so as to achieve performance of predetermined DC resistance. Copper plating is performed on front surfaces of the through holes 9a and 9b. Copper and the like is buried in each of the through holes 9a and 9b.

As illustrated in FIGS. 3(a) to 3(c), the number of installation places of the through holes 9a and 9b in the plate face direction of the board 3 is two: a position at which the inner end portions 4a₂ and 4b₂ of the coil patterns 4a and 4b are disposed, and a position at which the outer end portion 4b₁ of the coil pattern 4b and the inner end portion 4c₂ of the coil pattern 4c are disposed. This number is less than the number (three) of the layers of the board 3 in which the coil patterns 4a to 4c are provided, by 1. An installation place of the through hole 9a is closer to the opening portion 3m than an installation place of the through hole 9b, and is on an inside of a winding circumference of the coil patterns 4a to 4c.

The through holes 9a and 9b are an example of the “inter-layer connection portion” according to the present invention. The through hole 9a is an example of a “first inter-layer connection portion” according to the present invention. The through hole 9b is an example of a “second inter-layer connection portion” according to the present invention.

As another example, one through hole having a diameter greater than that of the through holes 9a and 9b may be provided in the installation place of each of the through holes 9a and 9b. The coil patterns 4a to 4c in the layers L1 to L3 different from each other may be connected to each other by using the through hole.

In order to easily form the through holes 9a and 9b, small patterns 4d formed of copper foils are respectively provided in the vicinity of the through hole 9b in the first layer L1, and in the vicinity of the through hole 9a in the third layer L3. Each of the through holes 9a and 9b is connected with the small pattern 4d. Insulating processing is performed on a front surface of the small pattern 4d in the first layer L1.

As illustrated in FIG. 3(c), the coil pattern 4c in the third layer L3 is wound outwardly clockwise around the opening portion 3m twice from the inner end portion 4c₂ (outward winding). An outer end portion 4c₁ of the coil pattern 4c is connected to the terminal 6i through the pad 8b and the through hole 8a.

With the above descriptions, the coil patterns 4a to 4c in the board 3 are wound firstly and secondly around the opening portion 3m (and the convex portion 2m of the core 2a) from the terminal 6i being a starting point, in the third layer L3, and then is connected to the second layer L2 through the through hole 9b. Then, the coil patterns 4a to 4c are wound thirdly and fourthly around the opening portion 3m in the second layer L2 and then is connected to the first layer L1 through the through hole 9a. The coil patterns 4a to 4c are wound fifthly and sixthly around the opening portion 3m in the first layer L1, and then is connected to the terminal 6o being an ending point. That is, the coil patterns 4a to 4c wound six times are formed in the three-layer board 3.

As described above, a current flowing in the magnetic device 1 is input from the terminal 6i, flows in an order of the coil pattern 4c, the through hole 9b, the coil pattern 4b, the through hole 9a, and the coil pattern 4a. Then, the current is output from the terminal 6o.

As illustrated in FIGS. 3(a) to 3(c), the heat-dissipation patterns 4t₀ to 4t₆ and 5s₀ to 5s₉ are provided in free spaces of the layers L1 to L3 of the board 3. Among these heat-dissipation patterns, the heat-dissipation patterns 4t₀ to 4t₆ are provided so as to be integrated with the coil patterns 4a to 4c by expanding portions of the coil patterns 4a to 4c in the plate face direction of the board 3. The heat-dissipation patterns 5s₀ to 5s₉ are provided so as to be separate from the coil patterns 4a to 4c such that the heat-dissipation patterns 5s₀ to 5s₉ are expanded in the plate face direction of the board 3. The heat-dissipation patterns 5s₀ to 5s₉ are also separate from each other.

The patterns 4a to 4d, 4t₀ to 4t₆, and 5s₀ to 5s₉ in the layers L1 to L3 are insulated from the screws 11. As illustrated in FIG. 3(a), in the first layer L1, the terminal 6i, and the through hole 8a and the pad 8b around the terminal 6i are insulated from the heat-dissipation pattern 4t₀ which is in the vicinity of the terminal 6i. The terminal 6o, and the through hole 8a and the pad 8b around the terminal 6o are connected to the heat-dissipation pattern 4t₂ and are insulated from the heat-dissipation pattern 5s₀.

As illustrated in FIG. 3(b), in the second layer L2, the terminals 6i and 6o and the through holes 8a around the terminals 6i and 6o are insulated from the heat-dissipation patterns 5s₃ and 4t₃ which are in the vicinity of the terminals 6i and 6o and the through holes 8a around the terminals 6i and 6o. As illustrated in FIG. 3(c), in the third layer L3, the terminal 6i and the through hole 8a around the terminal 6i are connected to the heat-dissipation pattern 4t₅ which is in the vicinity of the terminal 6i and the through hole 8a around the terminal 6i. The terminal 6o and the through hole 8a around the terminal 6o are connected to the heat-dissipation pattern 5s₉ which is in the vicinity of the terminal 6o and the through hole 8a around the terminal 6o, and are insulated from the heat-dissipation pattern 4t₆.

As illustrated in FIGS. 3(a) to 3(c), the heat-dissipation pattern 4t₀ in the first layer L1, the heat-dissipation pattern 5s₃ in the second layer L2, and the heat-dissipation pattern 5s₃ in the third layer L3 are connected to each other by using the heat-dissipation pin 7a, and the through hole 8d and the pad 8c around the heat-dissipation pin 7a. The heat-dissipation pattern 5s₁ in the first layer L1, the heat-dissipation pattern 4t₃ in the second layer L2, and the heat-dissipation pattern 5s₇ in the third layer L3 are connected to each other by using the heat-dissipation pin 7b, and the through hole 8d and the pad 8c around the heat-dissipation pin 7b.

The heat-dissipation pattern 4t₁ in the first layer L1, the heat-dissipation pattern 5s₄ in the second layer L2, and the heat-dissipation pattern 5s₆ in the third layer L3 are connected to each other by using the heat-dissipation pin 7c, the through hole 8d and the pad 8c around the heat-dissipation pin 7c. The heat-dissipation pattern 5s₂ in the first layer L1, the heat-dissipation pattern 4t₄ in the second layer L2, and the heat-dissipation pattern 5s₈ in the third layer L3 are connected to each other by using the heat-dissipation pin 7d, the through hole 8d and the pad 8c around the heat-dissipation pin 7d.

Since a high current flows in the coil patterns 4a to 4c, the coil patterns 4a to 4c function as a heat generation source, and thus the temperature of the board 3 increases. Heat generated by the coil pattern 4a in the first layer L1 is dissipated, for example, on the front surface of the coil pattern 4a or the front surfaces of the heat-dissipation patterns 4t₀ to 4t₂ and 5s₀ to 5s₂. The heat generated by the coil pattern 4a is, for example, transferred to the heat-dissipation patterns 5s₅, 5s₆, and 5s₉ and the like in the third layer L3 from the heat-dissipation pins 7a and 7b, the terminal 6o, or the like, and is dissipated through the insulating sheet 12 by the heat sink 10.

Heat generated by the coil pattern 4b in the second layer L2 is for example, diffused to the heat-dissipation patterns 4t₃ and 4t₄, and the like, and is transferred to the heat-dissipation patterns 5s₁, 5s₂, 5s₇, and 5s₈, and the like in the other layers L1 and L3 from the heat-dissipation pins 7b and 7d, or the like. The heat is diffused from the front surfaces of the heat-dissipation patterns 5s₁ and 5s₂ in the first layer L1, and the like, and is dissipated. In addition, the heat is transferred to the heat sink 10 from the heat-dissipation pattern 5s₇ and 5s₈ in the third layer L3 and is dissipated. Heat generated by the coil pattern 4c in the third layer L3 is, for example, transferred to the heat sink 10 from the coil pattern 4c or the heat-dissipation patterns 4t₅ and 4t₆ and is dissipated.

According to the first embodiment, since the coil patterns 4a to 4c are wound a plurality of times in the three layers L1 to L3 of the board 3, the number of winding of the coil patterns 4a to 4c as the entirety is twice or more the number of layers. For this reason, it is possible to increase the number of winding of the coil patterns 4a to 4c in the board 3 having the small number of layers. In this example, since each of the coil patterns 4a to 4c is wound twice in each of the layers L1 to L3, it is possible to realize the coil patterns 4a to 4c which are wound six times, in the three-layer board 3.

The coil patterns 4a to 4c in the layers L1 to L3 are spirally taken by performing inward winding or outward winding. The coil patterns 4a to 4c in the adjacent layers L1 to L3 are connected to each other at the inner end portions 4a₂, 4b₂, and 4c₂ or the outer end portion 4b₁ by using the through holes 9a and 9b provided in the board 3. The outer end portions 4a₁ and 4c₁ of the coil patterns 4a and 4c in the first layer L1 and the third layer L3 are connected to the terminals 6o and 6i. For this reason, for example, connection of the terminals 6o and 6i with the coil patterns 4a and 4c by out-of-board wiring (also referred to as aerial wiring) using a separate lead wire and the like is not required, and thus it is possible to easily perform wiring of the coil patterns 4a to 4c. It is possible to realize reduction of the size of the board 3 in the plate face direction by disposing the coil patterns 4a to 4c and the through holes 9a and 9b so as to approach the vicinity of the opening portion 3m of the board 3.

Since the number of installation places of the through holes 9a and 9b is less than the number of layers of the board 3, in which the coil patterns 4a to 4c are provided, by 1, the coil patterns 4a to 4c in the adjacent layers L1 to L3 are reliably connected to each other by using the through holes 9a and 9b, and thus it is possible to realize reduction of the size of the board 3 in the plate face direction. Since the coil patterns 4a to 4c are connected to each other by using the through holes 9a and 9b at two places, which pass through the layers L1 to L3 of the board 3, it is possible to easily manufacture the board 3 by forming these wires.

Since the terminals 6i and 6o for inputting and outputting power are provided on the outside of an outer circumference of the coil patterns 4a to 4c, it is possible to easily dispose the terminals 6i and 6o and the through holes 9a and 9b or to easily perform wiring of the coil patterns 4a to 4c. An increase of the size of the outer circumference of the coil patterns 4a to 4c is suppressed so as to be small, and thus it is possible to realize more reduction of the size of the board 3 in the plate face direction.

In the first embodiment, an example in which the coil patterns 4a to 4c are provided in each of the three layers L1 to L3 in the three-layer board 3 is described. However, the present invention is not limited thereto. As in the following second embodiment, coil patterns may be provided in each of layers of an odd number of 5 or more in a board.

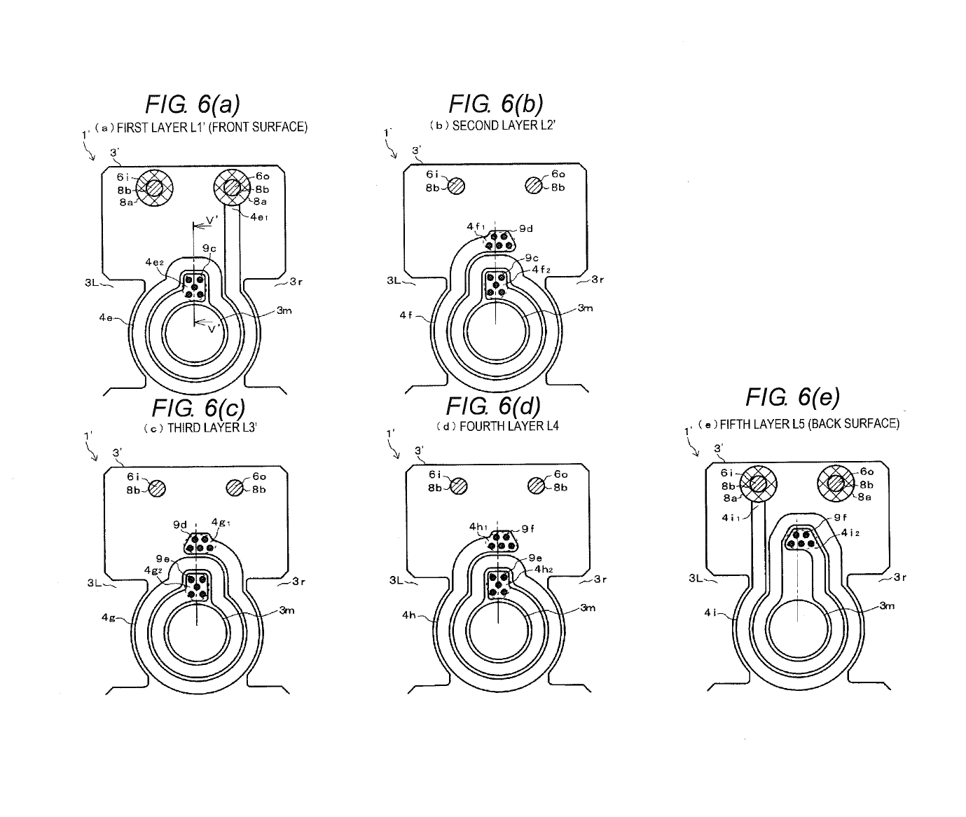

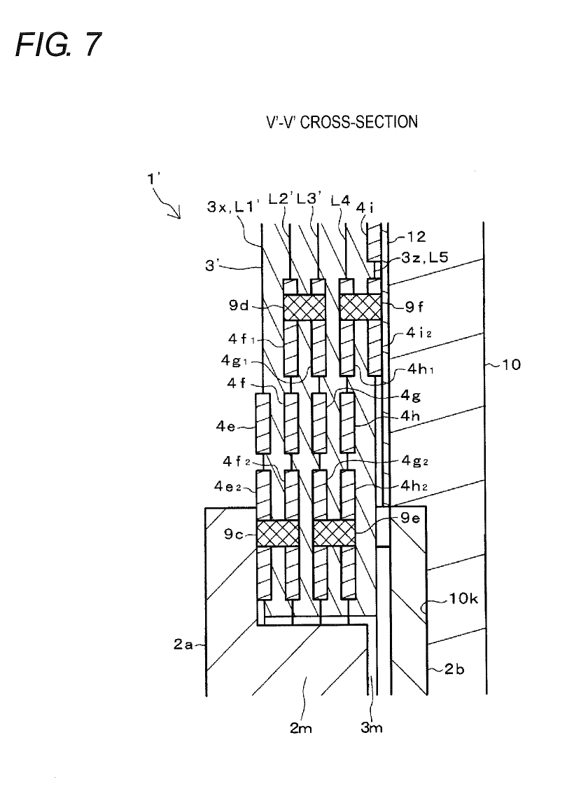

FIGS. 6(a) to 6(e) are plan views of main portions of each layer in a board 3′ of a magnetic device 1′ according to the second embodiment. FIG. 7 is a cross-sectional view of the magnetic device 1′ and illustrates a V′-V′ cross-section in FIGS. 6(a) to 6(e).

A first layer L1′ as illustrated in FIG. 6(a) is provided on the front surface (surface at a left end in FIG. 7) 3x of the board 3′ in the magnetic device 1′. A fifth layer L5 as illustrated in FIG. 6(e) is provided on the back surface (surface at a right end in FIG. 7) 3z of the board 3′. As illustrated in FIG. 7, a second layer L2′, a third layer L3′, and a fourth layer L4 as illustrated in FIGS. 6(b), 6(c), and 6(d) are provided between the first layer L1′ and the fifth layer L5.

That is, the board 3′ has five (odd number) layers L1′ to L5 of two front layers L1′ and L5 and three inner layers L2′, L3′, and L4. The first layer L1′ is provided firstly from the front surface 3x side of the board 3′, the second layer L2′ is provided secondly, the third layer L3′ is provided thirdly, the fourth layer L4 is provided fourthly, and the fifth layer L5 is provided fifthly. The fifth layer L5 is the last layer on the rear-most surface 3z side of the board 3′.

The terminals 6i and 6o are respectively buried in the through holes 8a provided in the board 3′. Coil patterns 4e to 4i formed of copper foils are provided in the layers L1′ to L5 of the board 3′. The width, the thickness, or the cross-sectional area of the coil patterns 4e to 4i is set to achieve predetermined performance of a coil and to suppress heat quantities in the coil patterns 4e to 4i up to a certain extent and enable heat dissipation from the front surfaces of the coil patterns 4e to 4i even when a predetermined high current flows.

The coil patterns 4e to 4i are wound a plurality of times around the opening portion 3m in the same direction in the layers L1′ to L5. The terminals 6i and 6o are provided on the outside of an outer circumference of the coil patterns 4e to 4i.

As illustrated in FIG. 6(a), an outer end portion 4e₁ of the coil pattern 4e is connected to the terminal 6o through the through hole 8a and the pad 8b in the first layer L1′. The coil pattern 4e is wound inwardly clockwise twice around the opening portion 3m from the outer end portion 4e₁ (inward winding). As illustrated in FIG. 7, an inner end portion 4e₂ of the coil pattern 4e is connected to an inner end portion 4f₂ of the coil pattern 4f in the second layer L2′ adjacent to the first layer L1′ on the back surface 3z side of the board 3′ by using a via 9c.

As illustrated in FIG. 6(b), the coil pattern 4f is wound outwardly clockwise twice around the opening portion 3m from the inner end portion 4f₂ (outward winding) in the second layer L2′. As illustrated in FIG. 7, an outer end portion 4f₁ of the coil pattern 4f is connected to an outer end portion 4g₁ of the coil pattern 4g in the third layer L3′ adjacent to the second layer L2′ on the back surface 3z side of the board 3′ by using a via 9d.

As illustrated in FIG. 6(c), the coil pattern 4g is wound inwardly clockwise twice around the opening portion 3m from the outer end portion 4g₁ (inward winding) in the third layer L3′. As illustrated in FIG. 7, an inner end portion 4g₂ of the coil pattern 4g is connected to an inner end portion 4h₂ of the coil pattern 4h in the fourth layer L4 adjacent to the third layer L3′ on the back surface 3z side of the board 3′ by using a via 9e.

As illustrated in FIG. 6(d), the coil pattern 4h is wound outwardly clockwise twice around the opening portion 3m from the inner end portion 4h₂ (outward winding) in the fourth layer L4. As illustrated in FIG. 7, an outer end portion 4h₁ of the coil pattern 4h is connected to an inner end portion 4i₂ of the coil pattern 4i in the fifth layer L5 adjacent to the fourth layer L4 the back surface 3z side of the board 3′ by using a via 9f

That is, the coil patterns in two layers which are different from each other and are adjacent to each other are connected to each other by using individual vias 9c to 9f. As illustrated in FIG. 7, the vias 9c to 9f are formed of an interstitial via hole (IVH) which does not pass through the board 3′. A plurality of vias having a small diameter as illustrated in FIGS. 6(a) to 6(e) is provided as each of the vias 9c to 9f, so as to achieve performance of predetermined DC resistance. Copper and the like may be buried in each of the vias 9c to 9f.

As illustrated in FIGS. 6(a) to 6(e), the number of installation places of the vias 9c to 9f is four; a place between the inner end portion 4e₂ of the coil pattern 4e and the inner end portion 4f₂ of the coil pattern 4f, a place between the outer end portion 4f₁ of the coil pattern 4f and the outer end portion 4g₁ of the coil pattern 4g, a place between the inner end portion 4g₂ of the coil pattern 4g and the inner end portion 4h₂ of the coil pattern 4h, and a place between the outer end portion 4h₁ of the coil pattern 4h and the inner end portion 41₂ of the coil pattern 4i. This number is less than the number (five) of layers of the board 3′, in which the coil patterns 4e to 4i are provided, by 1.

The number of installation places of the vias 9c to 9f in the plate face direction of the board 3′ is two: a position at which the inner end portions 4e₂ to 4h₂ of the coil patterns 4e to 4h are disposed, and a position at which the outer end portions 4b₁ to 4h₁ of the coil patterns 4b to 4h and the inner end portion 4i₂ of the coil pattern 4i are disposed.

The installation places of the vias 9c and 9e are closer to the opening portion 3m than the installation places of the vias 9d and 9f in the plate face direction of the board 3′, and are on the inside of a winding circumference of the coil patterns 4e to 4i. The vias 9c to 9f are an example of the “inter-layer connection portion” according to the present invention.

As another example, one via having a diameter greater than that of the vias 9c to 9f may be provided in the installation place of each of the vias 9c to 9f. The coil patterns 4e to 4i in the layers L1′ to L5 different from each other may be connected to each other by using the via.

As illustrated in FIG. 6(e), the coil pattern 4i is wound outwardly clockwise twice around the opening portion 3m from the inner end portion 4i₂ in the fifth layer L5 (outward winding). An outer end portion 4i₁ of the coil pattern 4i is connected to the terminal 6i through the pad 8b and the through hole 8a.

With the above descriptions, the coil patterns 4e to 4i in the board 3′ are wound firstly and secondly around the opening portion 3m from the terminal 6i being a starting point, in the fifth layer L5, and then is connected to the fourth layer L4 through the via 9f. Then, the coil patterns 4e to 4i are wound thirdly and fourthly around the opening portion 3m in the fourth layer L4 and then is connected to the third layer L3′ through the via 9e. Then, the coil patterns 4e to 4i are wound fifthly and sixthly around the opening portion 3m in the third layer L3′ and then is connected to the second layer L2′ through the via 9d. Then, the coil patterns 4e to 4i are wound seventhly and eighthly around the opening portion 3m in the second layer L2′ and then is connected to the first layer L1′ through the via 9c. The coil patterns 4e to 4i are wound ninthly and tenthly around the opening portion 3m in the first layer L1′, and then is connected to the terminal 6o being an ending point. That is, the coil patterns 4e to 4i wound ten times are formed in the five-layer board 3′.

As described above, a current flowing in the magnetic device 1′ is input from the terminal 6i, flows in an order of the coil pattern 4i, the via 9f, the coil pattern 4h, the via 9e, the coil pattern 4g, the via 9d, the coil pattern 4f, the via 9c, and the coil pattern 4e. Then, the current is output from the terminal 6o.

According to the second embodiment, since the coil patterns 4e to 4i are wound a plurality of times in the five layers L1′ to L5 of the board 3′, the number of winding of the coil patterns 4e to 4i as the entirety is twice or more the number of layers. For this reason, it is possible to increase the number of winding of the coil patterns 4e to 4i in the board 3′ having the small number of layers. In this example, it is possible to realize the coil patterns 4e to 4i which are wound ten times, in the five-layer board 3′.

The coil patterns 4e to 4i in the layers L1′ to L5 are taken spirally by performing inward winding or outward winding. The coil patterns 4e to 4i in the adjacent layers L1′ to L5 are connected to each other at the inner end portions 4e₂ to 4i₂ or the outer end portions 4f₁ to 4h₂ by using the vias 9c to 9f provided in the board 3′. The outer end portions 4e₁ and 4i₁ of the coil patterns 4e and 4i in the first layer L1′ and the fifth layer L5 are connected to the terminals 6o and 6i. For this reason, for example, connection of the terminals 6o and 6i with the coil patterns 4e and 4i by out-of-board wiring using a separate lead wire and the like is not required, and it is possible to easily perform wiring of the coil patterns 4e to 4i. It is possible to reduce the size of the board 3′ in the plate face direction by disposing the coil patterns 4e to 4i and the vias 9c to 9f so as to approach the vicinity of the opening portion 3m of the board 3′.

Since the vias 9c to 9f are provided at two places at which the inner end portions 4e₂ to 4i₂ and the outer end portions 4f₁ to 4h₁ of the coil patterns 4e to 4i are disposed, in the plate face direction of the board 3′, it is possible to ensure a current path of the coil patterns 4e to 4i and to realize more reduction of the size of the board 3′ in the plate face direction.

In the present invention, various embodiments can be employed in addition to the above descriptions. For example, in the above embodiments, examples in which the coil patterns 4a to 4c and 4e to 4i are respectively formed in the layers L1 to L3, L1′ to L5 of all of the three-layer board 3 and the five-layer board 3′ are described. However, the present invention is not limited to only these examples. In a board having three layers or more, coil patterns may be provided in each of layers of an odd number of three or more. When coil patterns are provided in each of layers of an odd number of seven or more, for example, a first layer from the front surface side of a board may be formed as illustrated in FIG. 6(a). The last layer may be formed as illustrated in FIG. 6(e). Even-numbered layers may be formed as illustrated in FIGS. 6(b) and 6(d). Other odd-numbered layers may be formed as illustrated in FIG. 6(c).

In the above embodiments, examples in which each of the coil patterns 4a to 4c and 4e to 4i is wound twice around the opening portion 3m into which the center convex portion 2m of the core 2a is inserted are described. However, the present invention is not limited to only these examples. In addition, for example, an opening portion formed of a through hole may be provided in a board instead of the notches 3L and 3r (FIG. 2 and the like) into which other convex portions 2L and 2r of the core 2a are respectively inserted, and a coil pattern may be wound three times or more around two or more of opening portions into which the convex portions 2m, 2L, and 2r are respectively inserted. The number of winding of a coil pattern in each layer is preferably set considering the size of the board. The width of the coil pattern is preferably widened in order to easily reduce heat quantities in the coil pattern or to easily dissipate heat from the front surface of the coil pattern.

In the above embodiments, examples in which the through holes 9a and 9b and the vias 9c to 9f are provided as the inter-layer connection portion in the boards 3 and 3′ are described. However, the present invention is not limited to only these examples. In addition, for example, another inter-layer connection portion formed of a conductor, such as a terminal, a pin, and a solder may be provided in a board and coil patterns in different layers may be connected to each other.

In the above embodiments, examples in which the terminals 6i and 6o formed of copper pins are provided as the terminal portions in the boards 3 and 3′ are described. However, the present invention is not limited to only these examples. In addition, for example, the terminals 6i and 6o may be omitted and the through hole 8a or the pad 8b may be provided as the terminal portions. Coil patterns may be connected to these terminal portions and be directly connected to other electronic components or circuits. For example, in a case of the switching power supply apparatus 100 illustrated in FIG. 1, cathodes of the diodes D1 and D2 in the rectifier circuit 54 may be connected to the terminal portions 8a and 8b (input side) of the coil pattern 4a by soldering. One end of the capacitor C in the smoothing circuit 55 or one end of a line linked to the output voltage detection circuit 59 and the output terminal T3 may be connected to the terminal portions 8a and 8b (output side) of the coil pattern 4b by soldering.

In the above embodiments, an example of using a thick copper foil board is described. However, the present invention is not limited to only this example. Other boards such as a printed board manufactured by using general resin, and a metallic board may be used. In a case of the metallic board, an insulating substance may be provided between a base and a coil pattern.

In the above embodiments, an example in which the I-shaped lower core 2b is combined with the E-shaped upper core 2a is described. However, the present invention may be also applied to a magnetic device having two E-shaped cores which are combined with each other.

In the above embodiments, an example in which the present invention is applied to the magnetic device 1 used as the choke coil L of the smoothing circuit 55 in the vehicle switching power supply apparatus 100 is described. However, the present invention may be also applied to a magnetic device used as the transformer 53 (FIG. 1). The present invention may be also applied to a magnetic device used in a switching power supply apparatus for, for example, electronic equipment in addition to a vehicle.

### DESCRIPTION OF REFERENCE SIGN(S)

1, 1′ MAGNETIC DEVICE

2a UPPER CORE

2b LOWER CORE

3, 3′ BOARD

3m OPENING PORTION

4a TO 4c, 4e TO 4i COIL PATTERN

6i, 6o TERMINAL

9a, 9b THROUGH HOLE

9c to 9f VIA

L1, L1′ FIRST LAYER

L2, L2′ SECOND LAYER

L3, L3′ THIRD LAYER

L4 FOURTH LAYER

L5 FIFTH LAYER

1. A magnetic device comprising:
a core; and
a board having an opening portion for inserting the core,
wherein coil patterns are provided in a plurality of layers of the board so as to be wound around the opening portion, the coil patterns in the layers different from each other are connected to each other by inter-layer connection portions, and power is input to and output from the coil patterns through a pair of terminal portions,
wherein the coil patterns are provided in respective layers of an odd number of three or more of the board, so as to be wound a plurality of times in a same direction,
wherein the coil pattern is wound outwardly from an inner end portion of the coil pattern in a last layer which is an odd-numbered layer from a front surface side of the board and which is located on a rear-most surface side of the board among the layers,
wherein the coil pattern is wound inwardly from an outer end portion of the coil pattern in each of other odd-numbered layers from the front surface side of the board other than the last layer,
wherein the coil pattern is wound outwardly from an outer end portion of the coil pattern in each of even-numbered layers,
wherein the inner end portion of the coil pattern in each of the odd-numbered layers and the inner end portion of the coil pattern in each of the even-numbered layers which is adjacent to the corresponding odd-numbered layer on a back surface side of the board are connected to each other by an individual inter-layer connection portion,
wherein an outer end portion of the coil pattern in each of the even-numbered layers, and an outer end portion of the coil pattern in each of the odd-numbered layers adjacent to the corresponding odd-numbered layer on the back surface side of the board or an inner end portion of the coil pattern in the last layer are connected to each other by the individual inter-layer connection portion,
wherein an outer end portion of the coil pattern in a first-numbered layer from the front surface side of the board is connected to one of the pair of terminal portions, and
wherein an outer end portion of the coil pattern in the last layer is connected to the other of the pair of terminal portions.

2. The magnetic device according to claim 1,
wherein the board is formed of a three-layer board,
wherein the coil pattern is wound inwardly from an outer end portion of the coil pattern in a first layer on the front-most surface side of the board,
wherein the coil pattern is wound outwardly from an inner end portion of the coil pattern in a second layer from the front surface side of the board,
wherein the coil pattern is wound outwardly from an inner end portion of the coil pattern in a third layer on a rear-most surface side of the board,
wherein the inter-layer connection portion is formed of:
a first inter-layer connection portion which connects an inner end portion of the coil pattern in the first layer and the inner end portion of the coil pattern in the second layer; and
a second inter-layer connection portion which connects an outer end portion of the coil pattern in the second layer and the inner end portion of the coil pattern in the third layer,
wherein the outer end portion of the coil pattern in the first layer is connected to the one of the pair of terminal portions, and
wherein an outer end portion of the coil pattern in the third layer is connected to the other of the pair of terminal portions.

3. The magnetic device according to claim 2,
wherein the first inter-layer connection portion and the second inter-layer connection portion pass through each of the layers of the board.

4. The magnetic device according to claim 1,
wherein the coil patterns are provided in each of layers of an odd number of five or more of the board, and
wherein each of the inter-layer connection portions is formed of a via which does not pass through the board.

5. The magnetic device according to claim 1,
wherein the pair of terminal portions are provided on an outside of an outer circumference of the coil pattern.
